(19) United States
(12) Patent Application Publication
(10) Pub. No.: US 2026/0129601 A1
(43) Pub. Date: May 7, 2026

(54) ARTIFICIAL INTELLIGENCE-BASED SMART ROAMING

(71) Applicant: QUALCOMM Incorporated, San Diego, CA (US)

(72) Inventors: Chao ZOU, San Jose, CA (US); Qiang FAN, Skillman, NJ (US); Gyanranjan HAZARIKA, Milpitas, CA (US); Tushnim BHATTACHARYYA, San Diego, CA (US); Vikram PHOGAT, FREMONT, CA (US); Gaurang NAIK, San Diego, CA (US); Sai Yiu Duncan HO, San Diego, CA (US); George CHERIAN, San Diego, CA (US); Vamsi Krishna NAIDU, Hyderabad (IN); Krishnakumar MUTHUSAMY, Danville, CA (US); Om Prakash TRIPATHI, Lathrop, CA (US); Yogesh SHEKAR, Milpitas, CA (US); Srinivas KATAR, Fremont, CA (US); Sandip HOMCHAUDHURI, San Jose, CA (US); Ye YUAN, Fremont, CA (US)

(21) Appl. No.: 18/935,422

(22) Filed: Nov. 1, 2024

(51) Int. Cl. H04W 64/00; H04B 17/318; H04W 24/02; H04W 28/24

(52) U.S. Cl. CPC H04W 64/00; H04B 17/318; H04W 24/02; H04W 28/24

(57) ABSTRACT

This disclosure provides methods, components, devices and systems for artificial intelligence-based smart roaming. Some aspects more specifically relate to artificial intelligence-driven based roaming. In some examples, the STA may input one or more parameters related to a current environment of the STA into the machine learning model. In some examples, the machine learning model may generate an output comprising at least a target AP for the STA to associate with. In some examples, the output of the machine learning model may include at least a target AP, a list of candidate APs a corresponding list of RSSI values associated with the list of candidate APs, or any combination thereof. In such examples, the list of candidate APs may include a set of APs located within an environment (such as an operating area) of the STA.

### TECHNICAL FIELD

This disclosure relates generally to wireless communication and, more specifically, to artificial intelligence-based smart roaming.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless communication device. The wireless communication device includes a processing system that includes processor circuitry and memory circuitry that stores code The processing system may be configured to cause a first wireless communication device to input a set of multiple parameters into a machine learning model, the set of multiple parameters including at least one of a location of the first wireless communication device, an a second wireless communication device connected to the first wireless communication device, a received signal strength indicator value of the second wireless communication device, and a current time value, receive a set of multiple outputs of the machine learning model, the set of multiple outputs including a list of wireless communication devices associated with the location of the first wireless communication device and a set of multiple received signal strength indicator values associated with the list of wireless communication devices, and associate with a target wireless communication device of the list of wireless communication devices in accordance with the set of multiple outputs including the list of wireless communication devices and the set of multiple received signal strength indicator values in accordance with the current time value.

Another innovative aspect of the subject matter described in this disclosure can be implemented in a method for wireless communication. The method includes inputting a set of multiple parameters into a machine learning model, the set of multiple parameters including at least one of a location of the first wireless communication device, a second wireless communication device) connected to the first wireless communication device, a received signal strength indicator value of the second wireless communication device, and a current time value, receiving a set of multiple outputs of the machine learning model, the set of multiple outputs including a list of wireless communication devices associated with the location of the first wireless communication device and a set of multiple received signal strength indicator values associated with the list of wireless communication devices, and associating with a target wireless communication device of the list of wireless communication devices in accordance with the set of multiple outputs including the list of wireless communication devices and the set of multiple received signal strength indicator values in accordance with the current time value.

Another innovative aspect of the subject matter described in this disclosure can be implemented in a wireless communication device. The wireless communication device includes means for inputting a set of multiple parameters into a machine learning model, the set of multiple parameters including at least one of a location of the first wireless communication device, a second wireless communication device connected to the first wireless communication device, a received signal strength indicator value of the second wireless communication device, and a current time value, means for receiving a set of multiple outputs of the machine learning model, the set of multiple outputs including a list of wireless communication devices associated with the location of the first wireless communication device and a set of multiple received signal strength indicator values associated with the list of wireless communication devices, and means for associating with a target wireless communication device of the list of wireless communication devices in accordance with the set of multiple outputs including the list of wireless communication devices and the set of multiple received signal strength indicator values in accordance with the current time value.

Another innovative aspect of the subject matter described in this disclosure can be implemented in a wireless communication device that includes non-transitory computer-readable medium storing code for wireless communication is described. The code may include instructions executable by one or more processors to input a set of multiple parameters into a machine learning model, the set of multiple parameters including at least one of a location of the first wireless communication device, a second wireless communication device connected to the first wireless communication device, a received signal strength indicator value of the second wireless communication device, and a current time value, receive a set of multiple outputs of the machine learning model, the set of multiple outputs including a list of wireless communication devices associated with the location of the first wireless communication device and a set of multiple received signal strength indicator values associated with the list of wireless communication devices, and associate with a target wireless communication device of the list of wireless communication devices in accordance with the set of multiple outputs including the list of wireless communication devices and the set of multiple received signal strength indicator values in accordance with the current time value.

Some examples of the method and wireless devices described herein may further include operations, features, means, or instructions for inputting the set of multiple parameters into the machine learning model, the set of multiple parameters including at least one of a series of locations of the first wireless communication device corresponding to an initial portion of a trajectory or a series of received signal strength indicator values and a first set of wireless communication devices located along the initial portion of the trajectory and predicting, by the machine learning model, a remainder of the trajectory of the first wireless communication device in accordance with inputting the series of parameters, the list of wireless communication devices corresponding to the remainder of the trajectory of the first wireless communication device.

Some examples of the method and wireless devices described herein may further include operations, features, means, or instructions for associating with the target wireless communication device of the list of wireless communication devices may be in accordance with predicting the remainder of the trajectory and the target wireless communication device including a next wireless communication device of the list of wireless communication devices along the trajectory.

Another innovative aspect of the subject matter described in this disclosure can be implemented in a wireless communication device. The wireless communication device includes a processing system that includes processor circuitry and memory circuitry that stores code. The processing system may be configured to cause the first wireless communication device to generate a set of multiple parameters associated with an environment of the first wireless communication device for inputting into a machine learning model, the set of multiple parameters including at least a location of the first wireless communication device, one or more received signal strength indicator values associated with one or more access points (wireless communication devices), a traffic pattern of the first wireless communication device, and a current time value, receive an output of the machine learning model in accordance with the set of multiple parameters, the output including an indication of a target wireless communication device for communications in accordance with the set of multiple parameters, and associate with the target wireless communication device in accordance with the output.

Another innovative aspect of the subject matter described in this disclosure can be implemented in a method for wireless communication. The method includes generating a set of multiple parameters associated with an environment of the first wireless communication device for inputting into a machine learning model, the set of multiple parameters including at least a location of the first wireless communication device, one or more received signal strength indicator values associated with one or more access points (wireless communication devices), a traffic pattern of the first wireless communication device, and a current time value, receiving an output of the machine learning model in accordance with the set of multiple parameters, the output including an indication of a target wireless communication device for communications in accordance with the set of multiple parameters, and associating with the target wireless communication device in accordance with the output.

Another innovative aspect of the subject matter described in this disclosure can be implemented in a wireless communication device. The wireless communication device includes means for generating a set of multiple parameters associated with an environment of the first wireless communication device for inputting into a machine learning model, the set of multiple parameters including at least a location of the first wireless communication device, one or more received signal strength indicator values associated with one or more access points (wireless communication devices), a traffic pattern of the first wireless communication device, and a current time value, means for receiving an output of the machine learning model in accordance with the set of multiple parameters, the output including an indication of a target wireless communication device for communications in accordance with the set of multiple parameters, and means for associating with the target wireless communication device in accordance with the output.

Another innovative aspect of the subject matter described in this disclosure can be implemented in a non-transitory computer-readable medium storing code for wireless communications is described. The code may include instructions executable by one or more processors to generate a set of multiple parameters associated with an environment of the first wireless communication device for inputting into a machine learning model, the set of multiple parameters including at least a location of the first wireless communication device, one or more received signal strength indicator values associated with one or more access points (wireless communication devices), a traffic pattern of the first wireless communication device, and a current time value, receive an output of the machine learning model in accordance with the set of multiple parameters, the output including an indication of a target wireless communication device for communications in accordance with the set of multiple parameters, and associate with the target wireless communication device in accordance with the output.

Some examples of the method an wireless communications devices may further include operations, features, means, or instructions for performing a single scanning procedure for the target wireless communication device, associating with the target wireless communication device being in accordance with one or more performance thresholds at the target wireless communication device satisfying one or more thresholds according to the single scanning procedure.

Some examples of the method an wireless communications devices may further include may further include operations, features, means, or instructions for selecting a reward function for the machine learning model in accordance with a service level agreement requirement of the first wireless communication device, receiving the indication of the target wireless communication device being in accordance with the reward function.

In some examples of the method an wireless communications devices may further include, the reward function may be in accordance with a throughput, a quality of service, a latency, a roaming overhead, an absence of a service level agreement requirement of the first wireless communication device, or any combination thereof.

### BRIEF DESCRIPTION OF THE DRAWINGS

FIG. 1 shows a pictorial diagram of an example wireless communication network.

FIG. 2 shows an example of an access point heat map according to an environment of a station (STA) usable for reassociating with a target access point (AP) that supports artificial intelligence-based smart roaming.

FIG. 3 shows an example of a block diagram illustrating trajectory prediction according to a movement of a STA that supports artificial intelligence-based smart roaming.

FIG. 4 shows an example of a block diagram illustrating receiving an output of a machine learning (ML) model including an indication of a target AP for association that supports artificial intelligence-based smart roaming.

FIG. 5 shows an example of a flowchart that illustrates generating a target AP for association and training one or more ML models that supports artificial intelligence-based smart roaming.

FIG. 6 shows a block diagram of an example wireless communication device that supports artificial intelligence-driven smart roaming at a device that includes a model component, and output component, an associating component, and a training component that support artificial intelligence-based smart roaming.

FIGS. 7 through 11 show flowcharts illustrating example processes performable by or at a station (STA) that supports artificial intelligence-based smart roaming.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, a wireless communication device, such as a station (STA), may roam between other wireless communication devices, such as access points (APs). In such examples, the STA may reassociate (such as switching a connection) from a first AP to a second AP (such as a target AP). In some examples, roaming between access points may occur in accordance with a threshold roaming trigger. For example, roaming may be triggered when a received signal strength indicator (RSSI) value falls below a fixed threshold. Further, the trigger may not be adapted for a roaming environment of the STA or AP. In such examples where the trigger corresponds to a relatively high RSSI threshold, the STA may initiate roaming unnecessarily. Further, in some other examples where the trigger corresponds to a relatively low RSSI threshold, the STA may refrain from initiating roaming and may remain connected to the first AP, while an additional AP (such as the second AP) may provide a greater signal or connection quality. Such premature roaming, or unnecessary roaming, may reduce operating efficiency and may increase system latency.

Additionally, or alternatively, reassociating with the target AP may be in accordance with a set of baseline characteristics (such as heuristic metrics) of the target AP. That is, the STA may reassociate with an AP based on characteristics of the AP that may not be adapted to a traffic pattern or environment of the STA.

In some examples, roaming between APs may include scanning for candidate APs, which may increase latency and overhead for the STA. Additionally, or alternatively, the target AP may be selected from the candidate APs according to a throughput value of the target AP (such as selecting an AP with a highest throughput of the candidate APs). In such examples, a service level agreement (SLA) of the STA (such as a quality of service (QoS)) may be different from a throughput of the AP, and selecting the target AP according to throughput may ignore the SLA of the STA. For example, the STA may associate with an AP that provides a relatively high throughput and a relatively low QoS when the STA may benefit from a higher QoS (without experiencing negative impact due to the lower throughput).

Various aspects relate generally to artificial intelligence-based smart roaming. Some aspects more specifically relate to identifying and associating with a target AP according to an output of a machine learning model. In some examples, the STA may input one or more parameters related to a current environment of the STA into the machine learning model. In such examples, the STA may input a current location of the STA, a list of RSSI values corresponding to neighbor APs (such as APs located within a threshold distance from the STA and within the operating area of the STA), a current time (such as an indication of the current time at which the STA is operating), or any combination thereof, into a machine learning model. Additionally, or alternatively, the STA may input a series of locations of the STA such as a series of locations comprising an initial portion of a path of the STA and a series of APs connected to the STA associated with the series of locations into the machine learning model.

Some examples more specifically relate to artificial intelligence-assisted smart roaming. In such examples, the STA may generate an output comprising at least a target AP for the STA to associate with (such as communicate with). In some examples, the output of the machine learning model may include a list of candidate APs and a corresponding list of RSSI values associated with the list of candidate APs. In such examples, the list of candidate APs may include a set of APs located within an environment (such as an operating area) of the STA. In such examples, the STA may select the target AP from the list of candidate APs (such as in accordance with a RSSI value associated with the target AP). In some other examples, where the input to the machine learning model includes a series of locations of the STA and one or more additional parameters, the list of candidate APs may be a series of candidate APs corresponding to a remainder of a path of the STA (such as along a trajectory of the STA). In such examples, the machine learning model may predict the remainder of the path according to the series of locations of the STA corresponding to an initial portion of the path. Additionally, or alternatively, the ML model may predict, according to the current time input, one or more additional remainders of the path of the STA (such as according to the same initial portion of the path). In such examples, the STA may select the target AP from the series of candidate APs (such as in accordance with a RSSI value associated with the target AP).

Some other aspects more specifically relate artificial intelligence-driven smart roaming including identifying and associating with a target AP according to an output of a machine learning model. In such examples, the STA may additionally input a traffic pattern of the STA, a neighbor AP report (such as a report including a set of capabilities associated with neighbor APs), or both into the machine learning model. Additionally, or alternatively, the machine learning model may be trained according to a reward function, which may be selected according to an SLA of the STA (such as a QoS agreement). In some examples, the output of the machine learning model may include a target AP for the STA to associate with. In some examples, the STA may associate with a target AP according to the output of the machine learning model indicating the target AP.

Particular aspects of the subject matter described in this disclosure can be implemented to realize one or more of the following potential advantages. In some examples relating to artificial intelligence-assisted smart roaming, by associating with the target AP according to the output of the machine learning model including the list of candidate APs via one or more of the techniques described herein, the STA may refrain from scanning for the candidate APs, which may reduce latency and overhead associated with roaming. Additionally, or alternatively, the STA may refrain from associating to an inefficient target AP unnecessarily, which may reduce overhead, and may enable a more stable connection.

Additionally, or alternatively, the techniques described herein relating to artificial intelligence-driven smart roaming support maintenance of STA SLAs. For example, the machine learning model may be trained with a reward function including a QoS agreement for the STA. In such examples, the target AP indicated in the output of the machine learning model may be an AP supporting communications with a relatively high QoS instead of an AP supporting a different metric (such as throughput). Such techniques may enable the STA to efficiently identify and associate with a target AP while maintaining the SLA of the STA. Additionally, or alternatively, the STA may refrain from scanning for the candidate APs, which may reduce latency and overhead associated with roaming. Additionally, or alternatively, the STA may refrain from associating to the target AP unnecessarily, which may reduce overhead, and may enable a more stable connection.

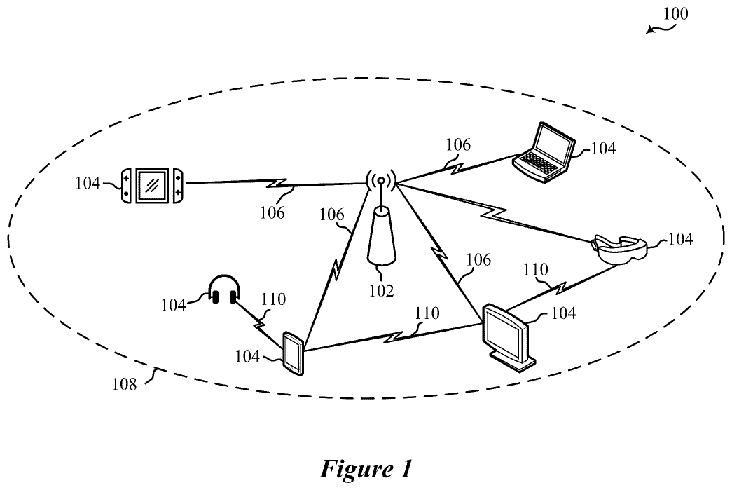

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHZ), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

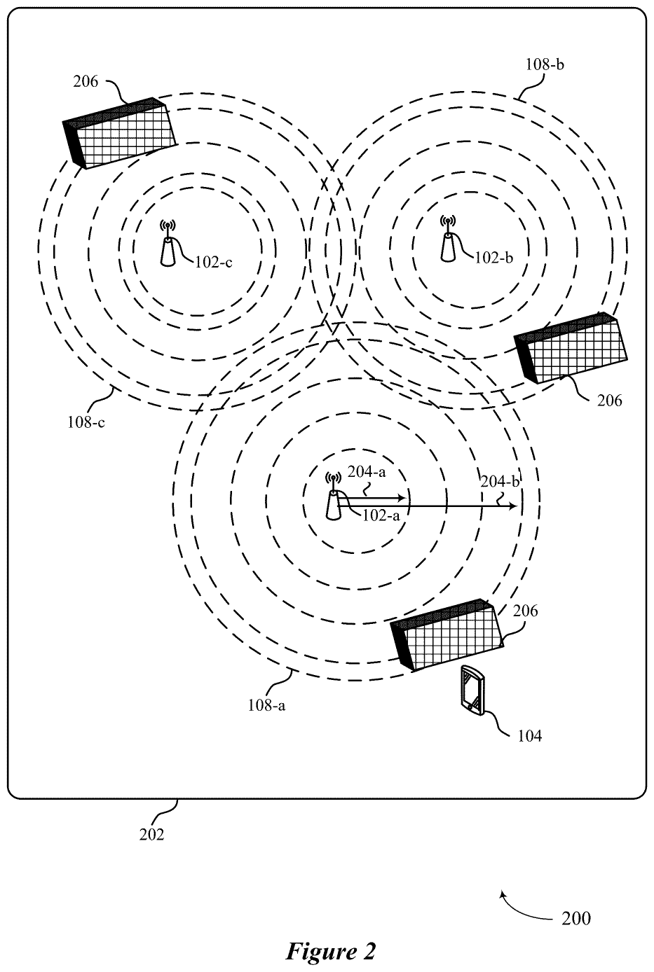

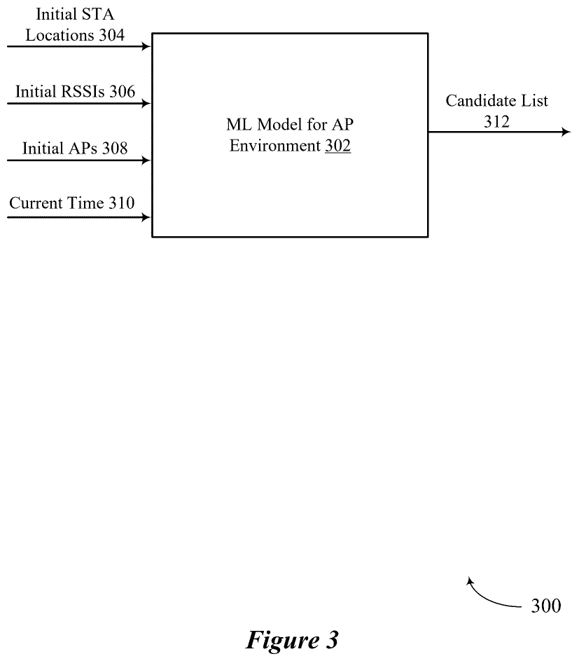

The AP 102, the STA 104, or both may perform artificial intelligence-assisted smart roaming. In such examples, the AP 102 or the STA 104 may utilize a ML model (such as a neural network (NN), a convolutional neural network (CNN), a recurrent neural network (RNN), a deep-Q neural network (DQN), a transformer network, or any combination thereof) to enhance one or more processes associated with roaming. For example, the ML model may improve roaming triggering, roaming scanning, AP scoring associated with roaming, and reassociating to a target AP, among other examples. Additionally, or alternatively, the ML model may enable the AP 102 or the STA 104 to refrain from performing certain processes associated with roaming (such as scanning, among other processes), and therefore may support power savings and improved efficiency at the STA 104, the AP 102, or both. The ML model may enable the AP 102 or the STA 104 to perform roaming procedures more efficiently in accordance with the ML model. Artificial intelligence-assisted smart roaming procedures are described in further detail herein with reference to FIGS. 2 and 3.

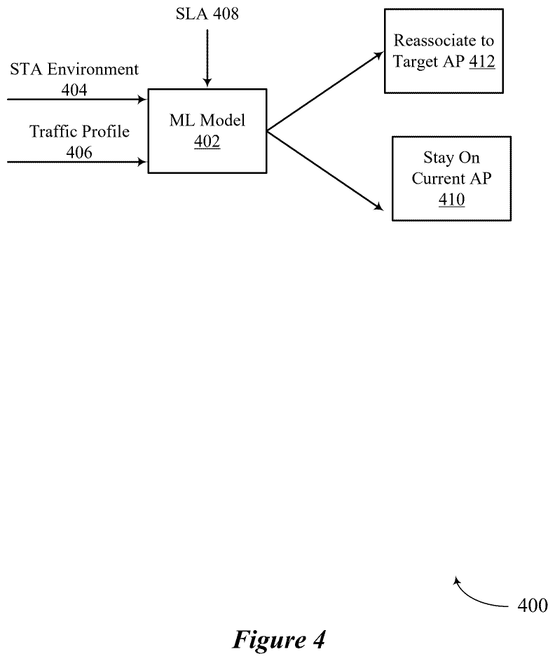

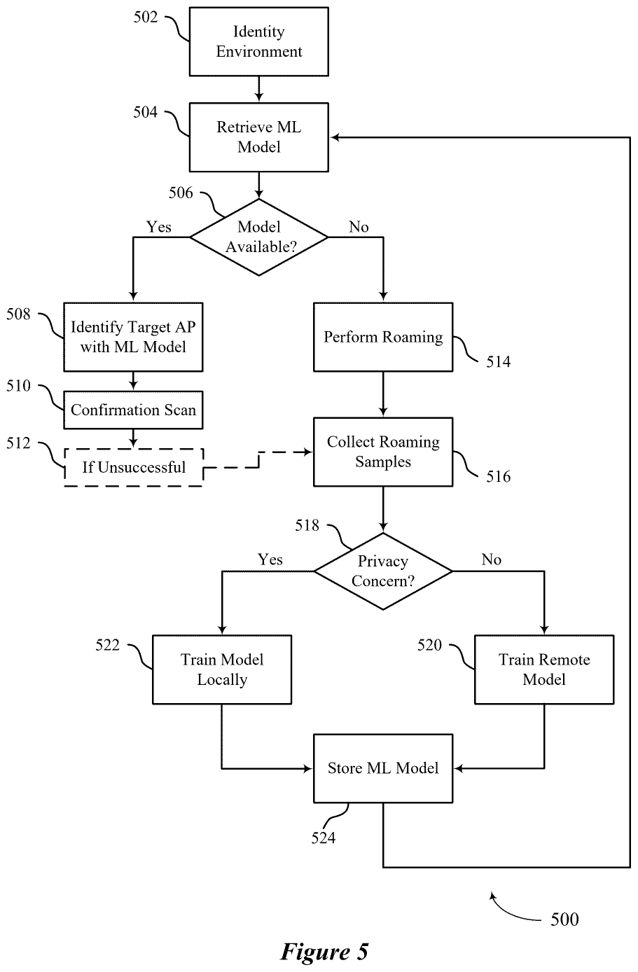

Additionally, or alternatively, the AP 102, the STA 104, or both may perform artificial intelligence-driven smart roaming. In such examples, the AP 102 or the STA 104 may utilize a ML model (such as a NN, a CNN, a RNN, a DQN, a transformer network, or any combination thereof) to replace one or more processes associated with roaming. The STA 104 may perform supervised learning using the ML model. That is, the triggering, scanning, AP scoring, and reassociating of roaming may be replaced with techniques for artificial intelligence-driven roaming. Further, in some examples, the artificial intelligence-driven roaming may enable AP selection with respect to one or more environmental parameters, such as a SLA of the AP 102 or the STA 104, a traffic pattern or profile of the AP 102 or the STA 104, an environment (such as an operating area) of the AP 102 or the STA 104, or any combination thereof. For instance, instead of performing triggering procedures, scanning procedures, AP scoring procedures, and resulting associations with a target AP 102, a STA 104 may input one or more parameters or environmental factors into an ML model, and an output of the ML model may indicate whether the STA 104 is to reassociate to a target AP 102, or to stay on a current AP 102. Artificial intelligence-driven smart roaming procedures are described in further detail herein with reference to FIGS. 4 and 5.

FIG. 2 shows an example of an AP heat map 200 that supports artificial intelligence-based smart roaming such as artificial intelligence-assisted roaming. In accordance with the AP heat map 200, an operating area 202 of a STA 104 may be a geographic area in which a STA 104 is operating (such as a building, city street, or other locations). The operating area 202 may include or be associated with multiple APs 102. As illustrated in the example of the AP heat map 200, the operating area 202 may include an AP 102-a, an AP 102-b, and an AP 102-c. Additionally, or alternatively, each AP 102 may be associated with a coverage area 108. In such examples, the AP 102-a, the AP 102-b, and the AP 102-c may be associated with a coverage area 108-a, a coverage area 108-b, and a coverage area 108-c, respectively, which may each be associated with one or more corresponding RSSI values (such as a RSSI value determined at the STA 104). The operating area 202 may include one or more obstructions 206 which may impact reception (such as, measured RSSI) for one or more STAs 104. Although the operating area 202 is illustrated as including three APs 102, an operating area 202 may include any quantity of APs 102 without exceeding the scope of the present disclosure. Further, although the procedures described herein with respect to FIG. 2 are illustrated as being implemented by the STA 104, the AP 102 or other wireless communication devices may implement the procedures without exceeding the scope of this present disclosure.

The AP heat map 200 may support artificial intelligence-assisted roaming techniques, including heat map prediction for the operating area 202. In some examples, the AP heat map 200 may be an example of a RSSI value heat map (such as a model floorplan associated with the operating area 202). The ML model may generate the AP heat map 200 for a current environment, so that a STA 104 or AP 102 can predict RSSI from other APs 102 to the roaming STA 104 based on the current observations (which may decrease the utilization of costly scanning because the STA 104 may refrain from performing any scanning to identify RSSI values for APs 102, or because the STA 104 may only perform scanning for APs 102 indicated by the AP heat map 200 or a list of candidate target APs 102).

In some examples, the STA 104 may input one or more parameters associated with the STA 104 into a ML model. In such examples, the STA 104 may input a current location of the STA 104 (such as coordinate points, a distance and an angle-of-attack with respect to the initial AP, or both), an initial AP connected to the STA 104 (such as one of the AP 102-a, AP 102-b, or AP 102-c, or another AP), a current time value, or any combination thereof into the machine learning model. In such examples, the current time value may be included according to the environment of the UE changing with respect to one or more events (such as human activities including variations to physical objects in the environment, a change to a quantity of wireless device in the environment, or other activities). Further, in such examples, the current time value may indicate a day of the week, a time of day, or other timing information. In some examples, the time input value may correspond to an hour-level granularity (such as not including further time subdivisions such as minutes or seconds). As such, the current time may enable the ML model to predict a heat map in accordance with the events or other parameters. For example, the output of the ML model (such as the AP heat map 200), may reflect human activity patterns, which may influence (such as induce) a multi-path pathloss corresponding to the environment of the STA (for instance, RSSI may be worse during times of day in which heavy pedestrian traffic occurs, and better other times of day).

In some implementations, the ML model may, in accordance with inputting the one or more parameters, output a list of candidate APs within the operating area 202 (such as APs within a threshold distance from the STA 104) and a list of RSSI values associated with the candidate APs. The list of candidate APs and RSSI values may represent an RSSI heat map associated with the operating area 202. Additionally, or alternatively, the output of the ML model may further include an indication of the candidate APs available channels (such as channels available for communication associated with each candidate APs). The output may additionally include one or more RSSI values (such as beacon RSSI values) associated with the available channels for the candidate APs. In such examples, the STA 104 may determine (such as, may predict) the nearby AP RSSI values according to the output of the ML model (such as, through an inference process of the STA 104). As such, the STA 104 may determine the nearby AP RSSI values while refraining from scanning the neighbor APs. In some examples, the output of the ML model (such as, the heat map) may indicate a gradient of RSSI values corresponding to each AP 102. For instance, the heat map may indicate multiple RSSI values corresponding to different distances at the given AP 102. As an illustrative example, an area located within a distance 204-a from the AP 102-a may correspond to a higher RSSI than an area located within a distance 204-b from the AP 102-a (which may be indicated by the heat map).

In some implementations, the STA 104 may associate with a target AP of the list of candidate APs according to at least an RSSI value associated with the target AP of the list of RSSI values. For example, the STA 104 may associate with AP 102-b according to the list of RSSI values output by the ML model. For example, the STA 104 may input environmental parameters into the ML model, and the ML model may output RSSI values (one or more RSSI values) for each of a list of APs 102. The STA 104 may select a neighbor AP from the list based on the input information (such as, without performing scanning, or may only scan the indicated APs 102). For instance, the ML model may indicate, to the STA 104, that an RSSI value (such as a predicted or ML-model generated RSSI value) for the AP 102-a is low (such as, due to the obstruction 206 located in the coverage area 108-a, or due to heavy usage by pedestrians at an indicated time of day). In such examples, the STA 104 cay instead connect to the AP 102-b, or another AP 102. That is, the STA 104 may associate with target AP (such was while refraining from scanning for the AP) within the operating area 202 in accordance with receiving the AP heat map 200 corresponding to the environment of the STA 104. In some implementations, the STA 104 may utilize multiple ML models corresponding to multiple environments. That is, each environment (such as an environment of the STA 104) may correspond to a different ML model. Additionally, or alternatively, the ML models may be stored at a remote server (such as a cloud server) or locally at the STA 104 or the AP 102. In examples where the ML models are stored at the remote server, the STA 104 may download the model (such as from the remote server) corresponding to a current environment of the STA 104 (such as in accordance with identifying the current environment). In such examples, downloading the ML model may include transmitting a request to the remote server requesting to download the ML model corresponding to the current environment, and receiving the requested ML model.

In some implementations, the STA 104 may train the multiple ML models (such as in accordance with multiple environments). In such implementations, the STA 104 may collect (such as, generate, among other examples) a set of training samples in accordance with scanning the environment of the STA 104. The training samples may include at least set of RSSI values and a set of locations of APs associated with the environment. In some examples, the STA 104 may upload the samples to the remote server such that a ML model corresponding to the environment of the STA 104 may be trained at the remote server. Additionally, or alternatively, one or more different STAs (such as other STAs not including the STA 104) may upload additional sets of training samples corresponding to the environment to the remote server. In some examples (such as where there may be a privacy concern associated with uploading the training samples to the remote server), the STA 104 may train a ML model locally (such as at the STA 104). In such examples, the STA 104 may, in accordance with training the ML model locally, upload the ML model to the remote server. In such examples where the ML model is trained locally and uploaded to the remote server, the remote server may aggregate the ML model with other ML models corresponding to the environment (such as in accordance with federated learning procedures).

Particular aspects of the subject matter described herein with respect to FIG. 2 can be implemented to realize one or more of the following potential advantages. For example, by inferring an AP to associate with according to the output of the ML model, the STA 104 may refrain from scanning for the neighbor APs, which may reduce latency and overhead associated with roaming. Further, in some other examples, utilizing the ML model input may enable the STA 104 to select a candidate according to a current environment of the STA 104, as well as according to changes to the environment of the STA 104.

FIG. 3 shows an example of a block diagram 300 that supports artificial intelligence-based smart roaming such as artificial intelligence-assisted roaming. The block diagram 300 may be implemented by an AP 102, a STA 104, other wireless communication devices, or any combination thereof. The block diagram 300 may include a ML model 302 (such as a NN, CNN, RNN, DQN, transformer network, or any combination thereof). The block diagram 300 may support artificial intelligence-driven smart roaming by enabling artificial intelligence-assisted trajectory prediction.

In some implementations, the STA 104 may input multiple parameters into the ML model 302. In some examples, the multiple parameters may include a series of initial locations 304 of the STA 104 (such as sequential coordinate points, a distance and an angle-of-attack with respect to the initial AP, or both). Additionally, or alternatively, the STA 104 may input a series of initial RSSI values 306 (such as RSSI values associated with a series of APs) into the ML model 302. In such examples, the STA 104 may input the initial RSSI values 306 in accordance with the initial locations 304 being unavailable, or the STA 104 may input both the initial locations 304 and the initial RSSI values 306. In some implementations, the initial locations 304, the initial RSSI values 306, or both may correspond to an initial portion of a path (such as a route or routine) of the STA 104.

In some implementations, the STA 104 may further input an indication of an initial series of APs 308 into the ML model 302. In some implementations, the APs 308 may be associated with the initial portion of the path of the STA 104. That is, the APs 308 may be a series of APs located along (such as within a threshold distance from) the initial portion of the path of the STA 104. For instance, a user may travel along one or more predictable or constant routes or paths (such as, to work, to school, to a store, among other examples). The STA 104 may, in such examples, pass an initial set of one or more APs 102 along a first portion of such a path. The APs 308 may be examples of APs 102 along the first portion of the path. Additionally, or alternatively, the STA 104 may further input a current time 310 into the ML model 302. In some examples, the current time 310 may be a day of the week (such as Monday, among other days), and an hour (such as 10:00 am). That is, the current time 310 may be expressed and input into the ML model 302 as an hour of the day corresponding to a day of the week.

In some implementations, the ML model 302 may output (such as generate, among other examples) a candidate list 312 corresponding to a remainder of the path of the STA 104. In some examples, the candidate list 312 may include a series of APs along the remainder of the path of the STA 104. For example, the ML model 302 may output the candidate list 312 along the remainder of the path of the STA 104 in accordance with the inputs indicating the initial portion of the path of the STA 104. In such examples, the STA 104 may associate with a target AP in accordance with the candidate list 312 along the path including the target AP, and with the STA 104 following the remainder of the path of the STA 104 (such as being within a threshold distance of the candidate AP).

Additionally, or alternatively, in some examples, the remainder of the path of the STA 104 (which may correspond to the candidate list 312) may vary with respect to a time of day, a day of the week, or both. A remainder of a path corresponding to an initial portion of a path at a first time may be different from a remainder of a path corresponding to the same initial portion of the path at a second time. As an example, in some examples, a routine of a user may follow a fixed pattern after a few steps or in a specified time slot. For instance, a user may leave home to go to an office in the morning, and the first few steps (such as, a first portion of a trajectory or path) may include entering a garage, and leaving the garage. This first portion may be the same regardless of whether the user is going to the office, or going to the grocery store. However, the ML model 302 may output APs along the path to the grocery store as an output in the evening, but may output APs along the path to the Office in the morning (such as, within a threshold time between the hours of 7:00 AM and 9:00 AM). Thus, the candidate list 312 may be different depending on the inputs such as the current time 310. As such, in some examples, the ML model 302 may output multiple different lists corresponding to different remainders of the path of the STA 104 according to the current time 310. In such examples, the STA 104 may associate with a target AP of a lists of APs corresponding to a remainder of the path of the STA 104 for the time current time 310. For instance, if a first path leads to an office, then the first target AP of the list of APs may be a next AP along the path to the office if the current time 310 indicates the first path, and if a second path leads to a grocery store, then the first target AP of the list of Aps may be a next Ap along the path to the grocery store.

In some implementations, the ML model 302 may be trained according to techniques described herein with respect to FIG. 2. In such examples, multiple ML models may correspond to multiple initial portions of paths for the STA 104. Additionally, or alternatively, the STA 104 may store the ML model 302 and the multiple ML models locally (such as at the STA 104), or the ML model 302 and the multiple ML models may be stored at a remote server (such as a cloud server).

Particular aspects of the subject matter described herein with respect to FIG. 3 can be implemented to realize one or more of the following potential advantages. For example, by inferring an AP to associate with according to the output of the ML model, the STA 104 may refrain from scanning for the neighbor APs, which may reduce latency and overhead associated with roaming. Further, in some other examples, utilizing the ML model input may enable the STA 104 to select a candidate according to a current trajectory or path of the STA 104, as well as according to changes to the environment of the STA 104 and the current time.

FIG. 4 shows an example of a block diagram 400 that supports artificial intelligence-based smart roaming such as artificial intelligence-driven roaming. The block diagram 400 may be implemented by an AP 102, a STA 104, other wireless communication devices, or any combination thereof. The block diagram 400 may include a ML model 402 (such as a NN, CNN, RNN, DQN, transformer network, or any combination thereof). Although the block diagram 400 is described herein with respect to FIG. 4 as being implemented by the STA 104, the AP 102 or another wireless device may implement the block diagram 400 without exceeding the scope of this present disclosure.

In some implementations, the STA 104 may input multiple parameters indicating an STA environment 404. In some examples, the STA environment 404 may include a location of the STA, a set of RSSI values associated with neighbor APs (such as APs located within a threshold distance from the STA 104, or within an operating area of the STA 104). Additionally, or alternatively, the STA environment 404 may include a neighbor AP report (such as a report including a set of configurations associated with the neighbor APs). In some examples, the STA 104 may generate the neighbor AP report, or may receive the neighbor AP report from another device. The STA 104 may further include, as an input to the ML model 402, a traffic pattern 406 of the STA 104, a current time value, or both. In some examples, the STA 104 may be connected to an initial AP.

Such techniques (such as artificial intelligence-driven roaming) may support improved handover to satisfy an SLA of the STA 104 or a load balancing threshold (requirement) of an AP 102. A target AP 102 indicated by the ML model 402 may not be an AP 102 having a highest throughput, but may be the AP 102 that most effectively satisfies a a roaming STA threshold or a QoS threshold. The ML model may be adjusted or improved via reinforcement learning (such as using deep-Q neural networks (DQNs).

In some implementations, the STA 104 may select a reward function for the ML model 402. In such examples, the reward function may be selected according to a SLA 408 of the STA 104. For example, the SLA 408 may be a QoS agreement, a throughput agreement, a latency agreement, other SLAs, or any combination thereof. In some examples, the STAs 104 may select or apply a throughput agreement as the reward function according to an absence of the SLA 408 (such as where the STA 104 does not have an explicit SLA). An illustrative example of selecting the reward function (such as a simple example which may be one of many candidate reward functions) according to throughput and latency may be given by the inequalities of Equation 1, shown below.

$$Reward = \{ \begin{matrix}1 , & if throughput \geq reqruied throughput \\ 1 , & if latency \leq required latency \\ 0 , & if throughput < required throughput \\ 0 , & if latency > required latency\end{matrix} \qquad ( 1 )$$

Additionally, or alternatively, the reward function may be selected according to the SLA 408 and a roaming overhead (such as a performance penalty associated with a roaming of the STA 104). That is, switching from a first AP to a second AP incurs a significant roaming overhead. In such examples, the roaming overhead may be represented by a roaming overhead value c. For example, c may be in accordance with the decision matrix of Equation 2, shown below, and the reward function may be selected according to the inequalities of Equation 3 (such as inequalities including various SLAs 408 and the roaming overhead c), shown below.

$$C = \{ \begin{matrix}c 1 , & \begin{matrix}if the action is to choose a different AP on different \\ channel from current serving AP\end{matrix} \\ c 2 , & \begin{matrix}if the action is to choose a different AP on the same \\ channel from current serving AP\end{matrix} \\ 0 , & if , if the action is to stay on the same AP\end{matrix} \qquad ( 2 )$$

$$Reward = \{ \begin{matrix}1 - C , & if throughput \geq reqruied throughput \\ 1 - C , & if latency \leq required latency \\ 0 - C , & if throughput < previous throughput \\ 0 - C , & if latency > previous latency\end{matrix} \qquad ( 3 )$$

Although the SLAs 408 depicted in Equation 1, Equation 2, and Equation 3 describe selecting a reward function according to the throughput agreement, the latency agreement, and the roaming overhead, the reward function may be selected according to other examples of SLAs 408 and other examples of roaming overheads without exceeding the scope of the present disclosure.

In some implementations, in accordance with inputting the STA environment 404 and the traffic pattern 406 and selecting the reward function according to the SLA 408, the ML model 402 may generate an output comprising an indication of a target AP (such as an AP satisfying the traffic pattern 406 and the SLA 408 and corresponding to the STA environment 404). In some examples, the target AP may be the initial AP. In such examples, at block 410, the STA 104 may determine to stay on the initial AP. That is, the initial AP may provide a greater quality of communication (such as compared to the neighbor APs) according to at least the traffic pattern 406 and the SLA 408. In some other examples, the target AP may be a different AP (such as at least one AP of the neighbor APs) than the initial AP. In such examples, at block 412, the STA 104 may associate with the target AP in accordance with the target AP providing a greater quality of communication (such as compared to the initial AP) according to at least the traffic pattern 406 and the SLA 408.

In some implementations, the STA 104 may initiate a handover procedure including associating with the target AP or staying on the initial AP in accordance with a traffic load of the STA 104, or to satisfy the SLA 408. Additionally, or alternatively, the AP 102 (such as the initial AP or the target AP) may initiate the handover procedure according to a traffic balancing condition of the AP 102.

In some implementations, the ML model 402 may be trained according to techniques described herein with respect to FIG. 5. In such examples, multiple ML models may correspond to multiple environments of the STA 104. Additionally, or alternatively, the STA 104 may store the ML model 402 and the multiple ML models locally (such as at the STA 104), or the ML model 402 and the multiple ML models may be stored at a remote server (such as a cloud server).

Particular aspects of the subject matter described herein with respect to FIG. 4 can be implemented to realize one or more of the following potential advantages. For example, by associating with the target AP according to the output of the ML model 402, the STA 104 may refrain from scanning for the neighbor APs, which may reduce latency and overhead associated with roaming. Further, in some other examples, utilizing the ML model 402 and including the STA environment 404 input may enable the STA 104 to select the target AP according to a current environment of the STA 104, as well as according to changes to the STA environment 404. That is, the target AP indicated by the output of the ML model 402 may be adapted (such as being continuously adapted) to the STA environment 404, which mUpay enable the STA 104 to communicate with a relatively well-performing AP for each changing environment of the STA 104. Additionally, or alternatively, the target AP indicated by the ML model 402 may be adapted to the SLA 408 of the STA 104, which may enable the STA 104 to associate with an AP that provides communication quality gains according to various SLAs 408 (such as SLAs other than a throughput agreement).

FIG. 5 shows an example of a flowchart 500 that illustrates artificial intelligence-based smart roaming such as artificial intelligence-driven roaming. The flowchart 500 may be implemented by an AP 102, a STA 104, or both. In some examples, the AP 102 or the STA 104 may perform the set of functions described below to perform a handover procedure according to an output of a ML model. Although the flowchart 500 is described herein with respect to FIG. 5 as being implemented by the STA 104, the AP 102 or other wireless communication devices may implement the block diagram 400 without exceeding the scope of this present disclosure.

At 502, the STA 104 may identify an environment of the STA 104. The environment of the STA may include an operating area of the STA 104 (such as a building, city street, or other physical locations of the STA 104). For example, the STA 104 may identify the operating area in accordance with one or more neighbor APs (such as APs within a threshold distance from the STA 104), an initial AP connected to the STA 104 (such as one of the neighbor APs), neighbor AP RSSI values, a cellular identification value (cellular ID), other indicators, or any combination thereof.

At 504, the STA 104 may attempt to retrieve (such as recall, receive, or download) an ML model associated with the environment of the STA 104. In such examples, the STA 104 may attempt to retrieve a local ML model (such as from a memory unit or a storage unit of the STA 104) corresponding to the environment of the STA 104, or a remote model (such as from a remote server or provided via another device) corresponding to the environment of the STA 104. Additionally, or alternatively, the STA 104 and the remote server may store multiple ML models corresponding to multiple environments (such as multiple operating areas) of the STA 104.

At 506, the STA 104 may determine if a ML model corresponding to the environment of the STA 104 is available (such as, if a ML model for the environment of the STA 104 has been trained). If the ML model is not available, the STA 104 may perform one or more steps corresponding to a training procedure at 514 such that the STA 104 may train a new ML model corresponding to the environment of the STA 104. If the ML model is available, the STA 104 may utilize the model at 508.

At 508, the STA 104 may identify, and input, one or more parameters (such as operating conditions) corresponding to the environment of the STA 104 into the ML mode. In some examples, the STA 104 may input a current location (such as a position) of the STA 104, a traffic pattern of the STA 104, a list of the neighbor APs, a neighbor AP report (such as a report indicating one or more capabilities of the nearby APs), a current time value, or other parameters into the ML model. Additionally, or alternatively, the STA 104 may input a SLA of the STA 104 (such as a throughput agreement, a QoS agreement, a latency agreement, or other SLAs) into the ML model such that a reward function may be selected. In such examples, the ML model may, in accordance with inputting the parameters by the STA 104, generate an output including an indication of a target AP (such that the STA 104 may associate with the target AP), which may be one of the neighbor APs.

In some examples (for instance, while training the ML model), at 510, the STA 104 may perform a confirmation scan of the target AP (such as scanning the target AP while refraining from scanning each neighbor AP). In some examples, the STA 104 may perform the confirmation scan to determine if the target AP indicated by the ML model satisfies one or more communication thresholds (such as the SLA or a RSSI value). In such examples, if the target AP satisfies the thresholds, the STA 104 may associate with the target AP while refraining from scanning each neighbor AP 102. In some other examples, if the target AP fails to satisfy the thresholds (such as at 512), the STA 104 may perform one or more steps corresponding to a training procedure at 516 such that the STA 104 may train a new ML model corresponding to the environment of the STA 104 in accordance with the sample obtained by performing the confirmation scan.

At 514 (such as the process step performed by the STA 104 in accordance with the ML model corresponding to the environment of the STA 104 being unavailable), the STA 104 may initiate roaming. In some examples, the STA 104 may, during the roaming, scan each AP within the environment of the STA 104 (such as within a threshold distance, or the neighbor APs).

At 516, the STA 104 may collect one or multiple training samples (such as samples for training a new or current ML model). In some examples, the training samples may include the samples obtained by the STA 104 during the roaming. Additionally, or alternatively, the training samples may include the sample obtained by the STA 104 during the confirmation scan of 510.

At 518, the STA 104 may determine whether there is a privacy concern associated with the training samples. That is, the STA 104 may determine whether there is a privacy concern associated with uploading the training samples to the remote server (such as directly uploading the training samples) such that a ML model may be trained remotely. If there is not a privacy concern associated with the training samples, the STA 104 may perform one or more steps corresponding to a training procedure at 520 such that the STA 104 may upload the training samples to the remote server remote model may be trained (such as directly trained using the training samples). The remote model may be trained in accordance with the training samples and in accordance with training samples obtained by one or more different STAs (such as different STAs associated with the environment of the STA). If there is a privacy concern associated with the training samples, the STA 104 may train a local ML model at 522.

At 522, the STA 104 may train the local ML model using the training samples. In such examples, the STA 104 may train the ML model locally (such as using hardware of the STA 104) while refraining from uploading the training samples to the remote server. Additionally, or alternatively, the STA 104 may upload the trained ML model to the remote server such that the STA 104 may request the ML model at a different time, or such that one or more different STAs may request the ML model associated with the environment of the STA (such as the environment in which the ML model was trained).

Additionally, or alternatively, at 524, the STA 104 may store either the local ML model, the remote ML model, or both at the STA 104 such that the STA 104 may retrieve the ML model at a different time (such as without downloading the model from the remote server). Additionally, or alternatively, the STA 104 may store (such as pre-store) multiple ML models corresponding to multiple environments of the STA such that the STA 104 may identity a target AP (such as a target AP of various APs associated with the multiple environments of the STA 104) without downloading the multiple ML models from the remote server.

Particular aspects of the subject matter described herein with respect to FIG. 5 can be implemented to realize one or more of the following potential advantages. For example, by associating with the target AP according to the output of the ML model, the STA 104 may refrain from scanning for neighbor APs, which may reduce latency and overhead associated with roaming. Additionally, or alternatively, training the remote model or the multiple remote models corresponding to multiple environments may enable multiple different STAs to perform artificial intelligence-driven roaming. Further, storing the multiple ML models at the remote server may enable the STA 104 and the multiple different STAs to relatively reduce memory usage and storage usage at the STA 104.

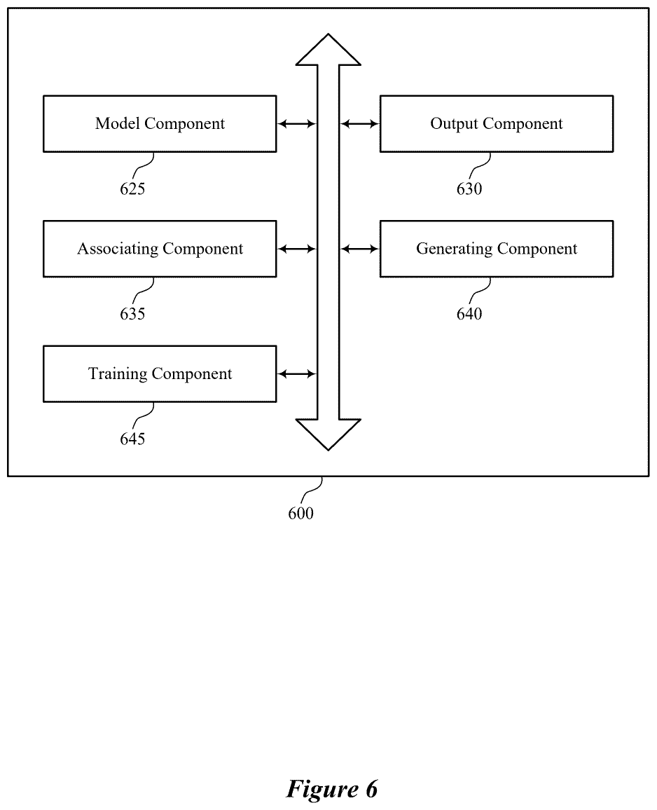

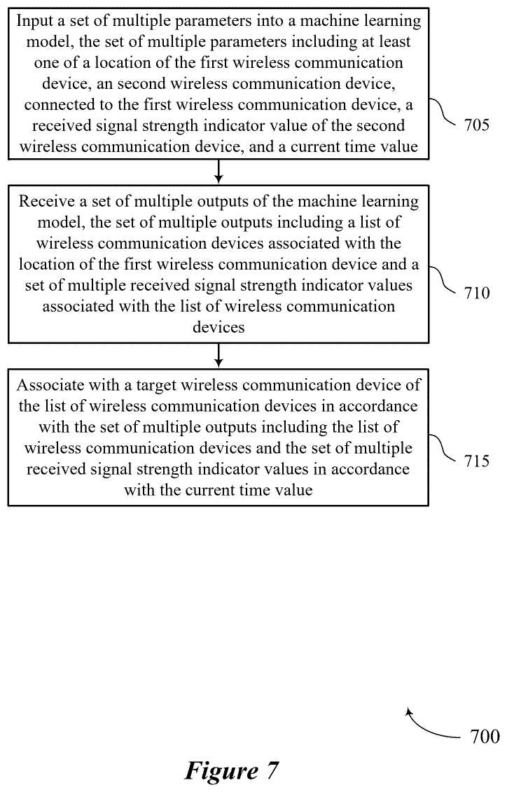

FIG. 6 shows a block diagram of an example wireless communication device 600 that supports artificial intelligence-based smart roaming. In some examples, the wireless communication device 600 is configured to perform the processes 700, 800, 900, 1000, and 1100 described with reference to FIGS. 7, 8, 9, 10, and 11, respectively. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in a first wireless communication device, such as the STA 104 or the AP 102 described with reference to FIG. 1. In some other examples, the wireless communication device 600 can be a first wireless communication device that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes a user interface (UI) (such as a touchscreen or keypad) and a display, which may be integrated with the UI to form a touchscreen display that is coupled with the processing system. In some examples, the wireless communication device 600 may further include one or more sensors such as, for example, one or more inertial sensors, accelerometers, temperature sensors, pressure sensors, or altitude sensors, that are coupled with the processing system.

The wireless communication device 600 includes a model component 625, an output component 630, an associating component 635, a generating component 640, and a training component 645. Portions of one or more of the model component 625, the output component 630, the associating component 635, the generating component 640, and the training component 645 may be implemented at least in part in hardware or firmware. For example, one or more of the model component 625, the output component 630, the associating component 635, the generating component 640, and the training component 645 may be implemented at least in part by at least a processor or a modem. In some examples, portions of one or more of the model component 625, the output component 630, the associating component 635, the generating component 640, and the training component 645 may be implemented at least in part by a processor and software in the form of processor-executable code stored in memory.

The wireless communication device 600 may support wireless communication in accordance with examples as disclosed herein. The model component 625 is configurable or configured to input a set of multiple parameters into a machine learning model, the set of multiple parameters including at least one of a location of the first wireless communication device, a second wireless communication device connected to the first wireless communication device, a received signal strength indicator value of the second wireless communication device, and a current time value. The output component 630 is configurable or configured to receive a set of multiple outputs of the machine learning model, the set of multiple outputs including a list of wireless communication devices associated with the location of the first wireless communication device and a set of multiple received signal strength indicator values associated with the list of wireless communication devices. The associating component 635 is configurable or configured to associate with a target wireless communication device of the list of wireless communication devices in accordance with the set of multiple outputs including the list of wireless communication devices and the set of multiple received signal strength indicator values in accordance with the current time value.

In some examples, the model component 625 is configurable or configured to input the set of multiple parameters into the machine learning model, the set of multiple parameters including at least one of a series of locations of the first wireless communication device corresponding to an initial portion of a trajectory or a series of received signal strength indicator values and a first set of wireless communication devices located along the initial portion of the trajectory. In some examples, the output component 630 is configurable or configured to predict, by the machine learning model, a remainder of the trajectory of the first wireless communication device in accordance with inputting the series of parameters, the list of wireless communication devices corresponding to the remainder of the trajectory of the first wireless communication device.

In some examples, associating with the target wireless communication device of the list of wireless communication devices is in accordance with predicting the remainder of the trajectory and the target wireless communication device including a next wireless communication device of the list of wireless communication devices along the trajectory.

In some examples, to support predicting the remainder of the trajectory, the associating component 635 is configurable or configured to select a first trajectory of a set of multiple candidate trajectories corresponding to the initial portion of the trajectory in accordance with the current time value.

In some examples, to support associating with the target wireless communication device, the associating component 635 is configurable or configured to select the target wireless communication device from the list of wireless communication devices in accordance with the set of multiple received signal strength indicator values associated with the list of wireless communication devices, the list of wireless communication devices including a list of candidate wireless communication devices satisfying a threshold signal strength.

In some examples, the set of multiple outputs includes a mapping of one or more candidate wireless communication devices of the list of wireless communication devices and received signal strength indicator values of the one or more candidate wireless communication devices, the received signal strength indicator values associated with an operating area corresponding to the first wireless communication device.

In some examples, the training component 645 is configurable or configured to scan an environment of the first wireless communication device for one or more wireless communication devices of the list of wireless communication devices during a training stage associated with the machine learning model. In some examples, the training component 645 is configurable or configured to generate a set of multiple training parameters for the machine learning model including a location of the one or more wireless communication devices, a received signal strength indicator value of each of the one or more wireless communication devices, or a combination thereof. In some examples, the training component 645 is configurable or configured to locally update the machine learning model at the first wireless communication device according to the set of multiple training parameters, sending the set of multiple training parameters for model training to a remote server, or both, inputting the set of multiple parameters into the machine learning model being in accordance with locally updating the machine learning model or sending the set of multiple training parameters to the remote server.

In some examples, one or more outputs of a remote machine learning model at the remote server are associated with a set of multiple inputs from a set of multiple first wireless communication devices.

In some examples, the model component 625 is configurable or configured to transmit a request to a remote server requesting to download the machine learning model. In some examples, the model component 625 is configurable or configured to retrieve the machine learning model from the remote server in accordance with transmitting the request, the machine learning model corresponding to a current operating area of the first wireless communication device.

In some examples, the associating component 635 is configurable or configured to refrain from performing an wireless communication device scanning procedure during an inference stage of the machine learning model in accordance with the set of multiple outputs of the machine learning model.

Additionally, or alternatively, the wireless communication device 600 may support wireless communications in accordance with examples as disclosed herein. The generating component 640 is configurable or configured to generate a set of multiple parameters associated with an environment of the first wireless communication device for inputting into a machine learning model, the set of multiple parameters including at least a location of the first wireless communication device, one or more received signal strength indicator values associated with one or more access points (wireless communication devices), a traffic pattern of the first wireless communication device, and a current time value. In some examples, the output component 630 is configurable or configured to receive an output of the machine learning model in accordance with the set of multiple parameters, the output including an indication of a target wireless communication device for communications in accordance with the set of multiple parameters. In some examples, the associating component 635 is configurable or configured to associate with the target wireless communication device in accordance with the output.

In some examples, the associating component 635 is configurable or configured to perform a single scanning procedure for the target wireless communication device, associating with the target wireless communication device being in accordance with one or more performance thresholds at the target wireless communication device satisfying one or more thresholds according to the single scanning procedure.

In some examples, the model component 625 is configurable or configured to select a reward function for the machine learning model in accordance with a service level agreement requirement of the first wireless communication device, receiving the indication of the target wireless communication device being in accordance with the reward function.

In some examples, the reward function is in accordance with a throughput, a quality of service, a latency, a roaming overhead, an absence of a service level agreement requirement of the first wireless communication device, or any combination thereof.

In some examples, the training component 645 is configurable or configured to scan an environment of the first wireless communication device for one or more wireless communication devices during a training stage for the machine learning model. In some examples, the training component 645 is configurable or configured to generate a set of multiple training parameters for the machine learning model including a location of the one or more wireless communication devices, a received signal strength indicator value of the one or more wireless communication devices, or a combination thereof. In some examples, the training component 645 is configurable or configured to locally update the machine learning model at the first wireless communication device according to the set of multiple training parameters, sending the set of multiple training parameters for model training to a remote server, or both, inputting the set of multiple parameters into the machine learning model being in accordance with locally updating the machine learning model or sending the set of multiple training parameters to the remote server.

In some examples, one or more outputs of a remote machine learning model at the remote server are associated with a set of multiple inputs from a set of multiple first wireless communication devices.

In some examples, the model component 625 is configurable or configured to transmit a request to a remote server requesting to download the machine learning model, the machine learning model for inferring the target wireless communication device. In some examples, the model component 625 is configurable or configured to retrieve the machine learning model from the remote server in accordance with transmitting the request, the machine learning model corresponding to the environment of the first wireless communication device.

In some examples, the output component 630 is configurable or configured to refrain from switching from a second wireless communication device connected to the first wireless communication device to a different wireless communication device in accordance with the initial second wireless communication device being the target wireless communication device indicated by the machine learning model.

In some examples, the model component 625 is configurable or configured to receive a neighbor wireless communication device report including a list of neighbor wireless communication devices located within a threshold distance from the first wireless communication device and one or more capabilities associated with the wireless communication devices. In some examples, the model component 625 is configurable or configured to include the list of neighbor wireless communication devices in the set of multiple parameters.

In some examples, the associating component 635 is configurable or configured to refrain from scanning one or more additional wireless communication devices that are different form the target wireless communication device in accordance with the output of the machine learning model.

In some examples, associating with the target wireless communication device is in accordance with a traffic balancing requirement of a second wireless communication device.

In some examples, the associating component 635 is configurable or configured to refrain from performing an wireless communication device scanning procedure during an inference stage of the machine learning model in accordance with the output of the machine learning model.

In some examples, the associating component 635 is configurable or configured to associate with a second target wireless communication device during an inference stage of the machine learning model in accordance with a traffic profile of the first wireless communication device, a quality of service requirement at the first wireless communication device, or both.

FIG. 7 shows a flowchart illustrating an example process 700 performable by or at a first wireless communication device that supports artificial intelligence-based smart roaming. The operations of the process 700 may be implemented by a first wireless communication device or its components as described herein. For example, the process 700 may be performed by a wireless communication device, such as the wireless communication device 600 described with reference to FIG. 6, operating as or within a wireless first wireless communication device. In some examples, the process 700 may be performed by a wireless first wireless communication device, such as one of the STAs 104 or APs 102 described with reference to FIG. 1.

In some examples, in 705, the first wireless communication device may input a set of multiple parameters into a machine learning model, the set of multiple parameters including at least one of a location of the first wireless communication device, a second wireless communication device connected to the first wireless communication device, a received signal strength indicator value of the second wireless communication device, and a current time value. The operations of 705 may be performed in accordance with examples as disclosed herein. In some implementations, aspects of the operations of 705 may be performed by a model component 625 as described with reference to FIG. 6.

In some examples, in 710, the first wireless communication device may receive a set of multiple outputs of the machine learning model, the set of multiple outputs including a list of wireless communication devices associated with the location of the first wireless communication device and a set of multiple received signal strength indicator values associated with the list of wireless communication devices. The operations of 710 may be performed in accordance with examples as disclosed herein. In some implementations, aspects of the operations of 710 may be performed by an output component 630 as described with reference to FIG. 6.

In some examples, in 715, the first wireless communication device may associate with a target wireless communication device of the list of wireless communication devices in accordance with the set of multiple outputs including the list of wireless communication devices and the set of multiple received signal strength indicator values in accordance with the current time value. The operations of 715 may be performed in accordance with examples as disclosed herein. In some implementations, aspects of the operations of 715 may be performed by an associating component 635 as described with reference to FIG. 6.

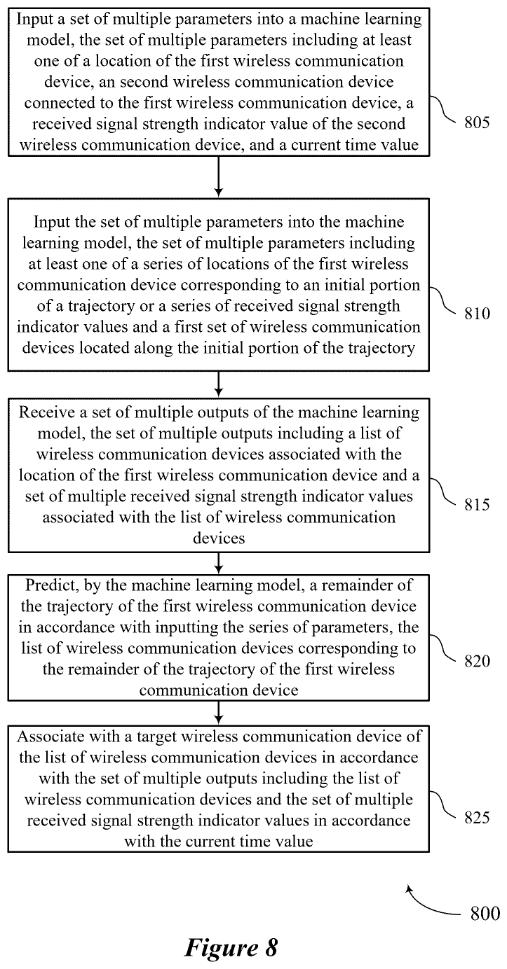

FIG. 8 shows a flowchart illustrating an example process 800 performable by or at a first wireless communication device that supports artificial intelligence-based smart roaming. The operations of the process 800 may be implemented by a first wireless communication device or its components as described herein. For example, the process 800 may be performed by a wireless communication device, such as the wireless communication device 600 described with reference to FIG. 6, operating as or within a wireless first wireless communication device. In some examples, the process 800 may be performed by a wireless first wireless communication device, such as one of the STAs 104 or APs 102 described with reference to FIG. 1.

In some examples, in 805, the first wireless communication device may input a set of multiple parameters into a machine learning model, the set of multiple parameters including at least one of a location of the first wireless communication device, a second wireless communication device connected to the first wireless communication device, a received signal strength indicator value of the second wireless communication device, and a current time value. The operations of 805 may be performed in accordance with examples as disclosed herein. In some implementations, aspects of the operations of 805 may be performed by a model component 625 as described with reference to FIG. 6.

In some examples, in 810, the first wireless communication device may input the set of multiple parameters into the machine learning model, the set of multiple parameters including at least one of a series of locations of the first wireless communication device corresponding to an initial portion of a trajectory or a series of received signal strength indicator values and a first set of wireless communication devices located along the initial portion of the trajectory. The operations of 810 may be performed in accordance with examples as disclosed herein. In some implementations, aspects of the operations of 810 may be performed by a model component 625 as described with reference to FIG. 6.

In some examples, in 815, the first wireless communication device may receive a set of multiple outputs of the machine learning model, the set of multiple outputs including a list of wireless communication devices associated with the location of the first wireless communication device and a set of multiple received signal strength indicator values associated with the list of wireless communication devices. The operations of 815 may be performed in accordance with examples as disclosed herein. In some implementations, aspects of the operations of 815 may be performed by an output component 630 as described with reference to FIG. 6.

In some examples, in 820, the first wireless communication device may predict, by the machine learning model, a remainder of the trajectory of the first wireless communication device in accordance with inputting the series of parameters, the list of wireless communication devices corresponding to the remainder of the trajectory of the first wireless communication device. The operations of 820 may be performed in accordance with examples as disclosed herein. In some implementations, aspects of the operations of 820 may be performed by an output component 630 as described with reference to FIG. 6.

In some examples, in 825, the first wireless communication device may associate with a target wireless communication device of the list of wireless communication devices in accordance with the set of multiple outputs including the list of wireless communication devices and the set of multiple received signal strength indicator values in accordance with the current time value. The operations of 825 may be performed in accordance with examples as disclosed herein. In some implementations, aspects of the operations of 825 may be performed by an associating component 635 as described with reference to FIG. 6.

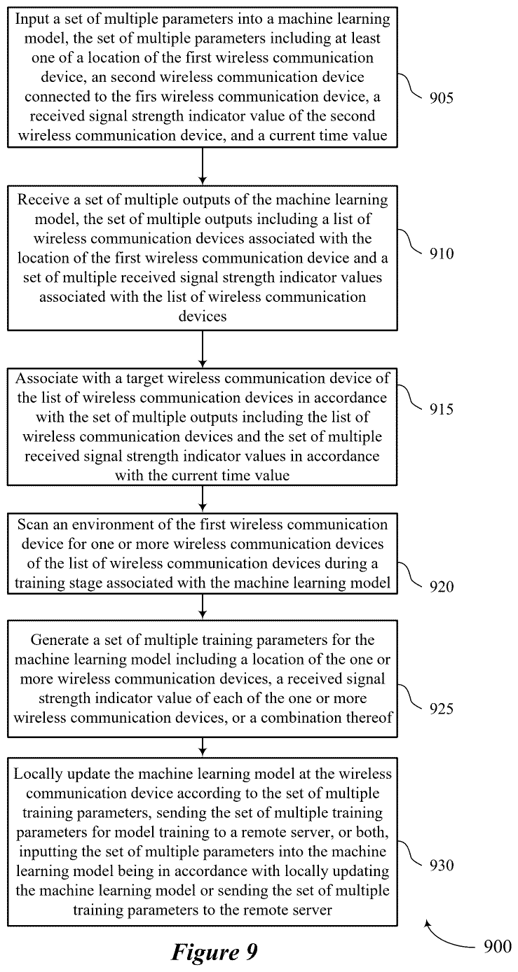

FIG. 9 shows a flowchart illustrating an example process 900 performable by or at a first wireless communication device that supports artificial intelligence-based smart roaming. The operations of the process 900 may be implemented by a first wireless communication device or its components as described herein. For example, the process 900 may be performed by a wireless communication device, such as the wireless communication device 600 described with reference to FIG. 6, operating as or within a wireless first wireless communication device. In some examples, the process 900 may be performed by a wireless first wireless communication device, such as one of the STAs 104 or APs 102 described with reference to FIG. 1.

In some examples, in 905, the first wireless communication device may input a set of multiple parameters into a machine learning model, the set of multiple parameters including at least one of a location of the first wireless communication device, a second wireless communication device connected to the first wireless communication device, a received signal strength indicator value of the second wireless communication device, and a current time value. The operations of 905 may be performed in accordance with examples as disclosed herein. In some implementations, aspects of the operations of 905 may be performed by a model component 625 as described with reference to FIG. 6.

In some examples, in 910, the first wireless communication device may receive a set of multiple outputs of the machine learning model, the set of multiple outputs including a list of wireless communication devices associated with the location of the first wireless communication device and a set of multiple received signal strength indicator values associated with the list of wireless communication devices. The operations of 910 may be performed in accordance with examples as disclosed herein. In some implementations, aspects of the operations of 910 may be performed by an output component 630 as described with reference to FIG. 6.

In some examples, in 915, the first wireless communication device may associate with a target wireless communication device of the list of wireless communication devices in accordance with the set of multiple outputs including the list of wireless communication devices and the set of multiple received signal strength indicator values in accordance with the current time value. The operations of 915 may be performed in accordance with examples as disclosed herein. In some implementations, aspects of the operations of 915 may be performed by an associating component 635 as described with reference to FIG. 6.

In some examples, in 920, the first wireless communication device may scan an environment of the first wireless communication device for one or more wireless communication devices of the list of wireless communication devices during a training stage associated with the machine learning model. The operations of 920 may be performed in accordance with examples as disclosed herein. In some implementations, aspects of the operations of 920 may be performed by a training component 645 as described with reference to FIG. 6.

In some examples, in 925, the first wireless communication device may generate a set of multiple training parameters for the machine learning model including a location of the one or more wireless communication devices, a received signal strength indicator value of each of the one or more wireless communication devices, or a combination thereof. The operations of 925 may be performed in accordance with examples as disclosed herein. In some implementations, aspects of the operations of 925 may be performed by a training component 645 as described with reference to FIG. 6.

In some examples, in 930, the first wireless communication device may locally update the machine learning model at the first wireless communication device according to the set of multiple training parameters, sending the set of multiple training parameters for model training to a remote server, or both, inputting the set of multiple parameters into the machine learning model being in accordance with locally updating the machine learning model or sending the set of multiple training parameters to the remote server. The operations of 930 may be performed in accordance with examples as disclosed herein. In some implementations, aspects of the operations of 930 may be performed by a training component 645 as described with reference to FIG. 6.

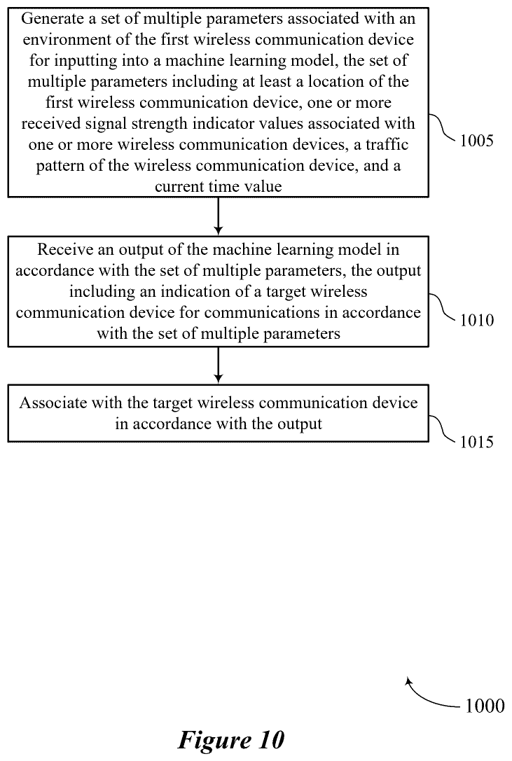

FIG. 10 shows a flowchart illustrating an example process 1000 performable by or at a first wireless communication device that supports artificial intelligence-based smart roaming. The operations of the process 1000 may be implemented by a first wireless communication device or its components as described herein. For example, the process 1000 may be performed by a wireless communication device, such as the wireless communication device 600 described with reference to FIG. 6, operating as or within a wireless first wireless communication device. In some examples, the process 1000 may be performed by a wireless first wireless communication device, such as one of the STAs 104 or APs 102 described with reference to FIG. 1.

In some examples, in 1005, the first wireless communication device may generate a set of multiple parameters associated with an environment of the first wireless communication device for inputting into a machine learning model, the set of multiple parameters including at least a location of the first wireless communication device, one or more received signal strength indicator values associated with one or more access points (wireless communication devices), a traffic pattern of the first wireless communication device, and a current time value. The operations of 1005 may be performed in accordance with examples as disclosed herein. In some implementations, aspects of the operations of 1005 may be performed by a generating component 640 as described with reference to FIG. 6.

In some examples, in 1010, the first wireless communication device may receive an output of the machine learning model in accordance with the set of multiple parameters, the output including an indication of a target wireless communication device for communications in accordance with the set of multiple parameters. The operations of 1010 may be performed in accordance with examples as disclosed herein. In some implementations, aspects of the operations of 1010 may be performed by an output component 630 as described with reference to FIG. 6.

In some examples, in 1015, the first wireless communication device may associate with the target wireless communication device in accordance with the output. The operations of 1015 may be performed in accordance with examples as disclosed herein. In some implementations, aspects of the operations of 1015 may be performed by an associating component 635 as described with reference to FIG. 6.

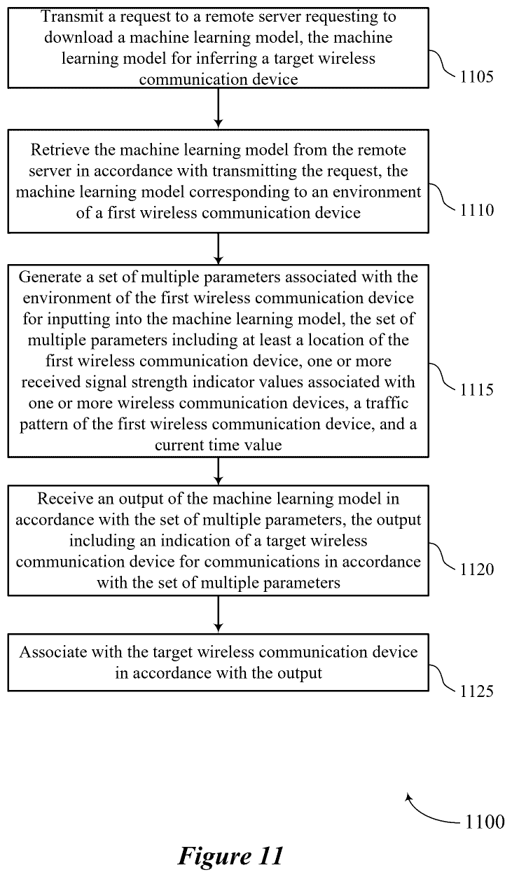

FIG. 11 shows a flowchart illustrating an example process 1100 performable by or at a first wireless communication device that supports artificial intelligence-based smart roaming. The operations of the process 1100 may be implemented by a first wireless communication device or its components as described herein. For example, the process 1100 may be performed by a wireless communication device, such as the wireless communication device 600 described with reference to FIG. 6, operating as or within a wireless first wireless communication device. In some examples, the process 1100 may be performed by a wireless first wireless communication device, such as one of the STAs 104 or APs 102 described with reference to FIG. 1.

In some examples, in 1105, the first wireless communication device may transmit a request to a remote server requesting to download the machine learning model, the machine learning model for inferring the target wireless communication device. The operations of 1105 may be performed in accordance with examples as disclosed herein. In some implementations, aspects of the operations of 1105 may be performed by a model component 625 as described with reference to FIG. 6.

In some examples, in 1110, the first wireless communication device may retrieve the machine learning model from the remote server in accordance with transmitting the request, the machine learning model corresponding to the environment of the first wireless communication device. The operations of 1110 may be performed in accordance with examples as disclosed herein. In some implementations, aspects of the operations of 1110 may be performed by a model component 625 as described with reference to FIG. 6.

In some examples, in 1115, the first wireless communication device may generate a set of multiple parameters associated with an environment of the first wireless communication device for inputting into a machine learning model, the set of multiple parameters including at least a location of the first wireless communication device, one or more received signal strength indicator values associated with one or more access points (wireless communication devices), a traffic pattern of the first wireless communication device, and a current time value. The operations of 1115 may be performed in accordance with examples as disclosed herein. In some implementations, aspects of the operations of 1115 may be performed by a generating component 640 as described with reference to FIG. 6.

In some examples, in 1120, the first wireless communication device may receive an output of the machine learning model in accordance with the set of multiple parameters, the output including an indication of a target wireless communication device for communications in accordance with the set of multiple parameters. The operations of 1120 may be performed in accordance with examples as disclosed herein. In some implementations, aspects of the operations of 1120 may be performed by an output component 630 as described with reference to FIG. 6.

In some examples, in 1125, the first wireless communication device may associate with the target wireless communication device in accordance with the output. The operations of 1125 may be performed in accordance with examples as disclosed herein. In some implementations, aspects of the operations of 1125 may be performed by an associating component 635 as described with reference to FIG. 6.

Implementation examples are described in the following numbered clauses:

The following provides an overview of aspects of the present disclosure:
Aspect 1: A method for wireless communication at a first wireless communication device, comprising: inputting a plurality of parameters into a machine learning model, the plurality of parameters comprising at least one of a location of the first wireless communication device, a second wireless communication device connected to the first wireless communication device, a received signal strength indicator value of the second wireless communication device, and a current time value; receiving a plurality of outputs of the machine learning model, the plurality of outputs comprising a list of wireless communication devices associated with the location of the first wireless communication device and a plurality of received signal strength indicator values associated with the list of wireless communication devices; and associating with a target wireless communication device of the list of wireless communication devices in accordance with the plurality of outputs comprising the list of wireless communication devices and the plurality of received signal strength indicator values in accordance with the current time value.
Aspect 2: The method of aspect 1, further comprising: inputting the plurality of parameters into the machine learning model, the plurality of parameters comprising at least one of a series of locations of the first wireless communication device corresponding to an initial portion of a trajectory or a series of received signal strength indicator values and a first set of wireless communication devices located along the initial portion of the trajectory; and predicting, by the machine learning model, a remainder of the trajectory of the first wireless communication device in accordance with inputting the series of parameters, the list of wireless communication devices corresponding to the remainder of the trajectory of the first wireless communication device.
Aspect 3. The method of aspect 2, wherein associating with the target wireless communication device of the list of wireless communication devices is in accordance with predicting the remainder of the trajectory and the target wireless communication device comprising a next wireless communication device of the list of wireless communication devices along the trajectory.
Aspect 4: The method of any of aspects 2 through 3, wherein predicting the remainder of the trajectory further comprises: selecting a first trajectory of a plurality of candidate trajectories corresponding to the initial portion of the trajectory in accordance with the current time value.
Aspect 5: The method of any of aspects 1 through 4 wherein associating with the target wireless communication device further comprises: selecting the target wireless communication device from the list of wireless communication devices in accordance with the plurality of received signal strength indicator values associated with the list of wireless communication devices, the list of wireless communication devices comprising a list of candidate wireless communication devices satisfying a threshold signal strength.
Aspect 6: The method of aspect 1 wherein the plurality of outputs comprises a mapping of one or more candidate wireless communication devices of the list of wireless communication devices and received signal strength indicator values of the one or more candidate wireless communication devices, the received signal strength indicator values associated with an operating area corresponding to the first wireless communication device.
Aspect 7: The method of any of aspects 1 through 6, further comprising: scanning an environment of the first wireless communication device for one or more wireless communication devices of the list of wireless communication devices during a training stage associated with the machine learning model; generating a plurality of training parameters for the machine learning model comprising a location of the one or more wireless communication devices, a received signal strength indicator value of each of the one or more wireless communication devices, or a combination thereof; and locally updating the machine learning model at the first wireless communication device according to the plurality of training parameters, sending the plurality of training parameters for model training to a remote server, or both, inputting the plurality of parameters into the machine learning model being in accordance with locally updating the machine learning model or sending the plurality of training parameters to the remote server.
Aspect 8: The method of aspect 7, wherein one or more outputs of a remote machine learning model at the remote server are associated with a plurality of inputs from a plurality of first wireless communication devices.
Aspect 9: The method of aspect 1, further comprising: transmitting a request to a remote server requesting to download the machine learning model; and retrieving the machine learning model from the remote server in accordance with transmitting the request, the machine learning model corresponding to a current operating area of the first wireless communication device.
Aspect 10: The method of aspect 9, further comprising: retrieving the machine learning model from a local storage at the first wireless communication device, the machine learning model corresponding to the environment of the first wireless communication device.
Aspect 11: The method of any of aspects 1 through 10, further comprising: refraining from performing an wireless communication device scanning procedure during an inference stage of the machine learning model in accordance with the plurality of outputs of the machine learning model.
Aspect 12: The method of any of aspects 1 through 11, wherein the first wireless communication device is a STA, and the second wireless communication device is an AP.
Aspect 13: The method of any of aspects 1 through 11, wherein the first wireless communication device is an AP, and the second wireless communication device is a STA.
Aspect 14: A method for wireless communications at a first wireless communication device, comprising: generating a plurality of parameters associated with an environment of the first wireless communication device for inputting into a machine learning model, the plurality of parameters comprising at least a location of the first wireless communication device, one or more received signal strength indicator values associated with one or more access points (wireless communication devices), a traffic pattern of the first wireless communication device, and a current time value; receiving an output of the machine learning model in accordance with the plurality of parameters, the output comprising an indication of a target wireless communication device for communications in accordance with the plurality of parameters; and associating with the target wireless communication device in accordance with the output.
Aspect 15: The method of aspect 14, further comprising: performing a single scanning procedure for the target wireless communication device, associating with the target wireless communication device being in accordance with one or more performance thresholds at the target wireless communication device satisfying one or more thresholds according to the single scanning procedure.
Aspect 16: The method of aspect 14, further comprising: selecting a reward function for the machine learning model in accordance with a service level agreement requirement of the first wireless communication device, receiving the indication of the target wireless communication device being in accordance with the reward function.
Aspect 17: The method of aspect 16, wherein the reward function is in accordance with a throughput, a quality of service, a latency, a roaming overhead, an absence of a service level agreement requirement of the first wireless communication device, or any combination thereof.
Aspect 18: The method of any of aspects 14 through 17, further comprising: scanning an environment of the first wireless communication device for one or more wireless communication devices during a training stage for the machine learning model; generating a plurality of training parameters for the machine learning model comprising a location of the one or more wireless communication devices, a received signal strength indicator value of the one or more wireless communication devices, or a combination thereof; and locally updating the machine learning model at the first wireless communication device according to the plurality of training parameters, sending the plurality of training parameters for model training to a remote server, or both, inputting the plurality of parameters into the machine learning model being in accordance with locally updating the machine learning model or sending the plurality of training parameters to the remote server.
Aspect 19: The method of aspect 18, wherein one or more outputs of a remote machine learning model at the remote server are associated with a plurality of inputs from a plurality of first wireless communication devices.
Aspect 20: The method of aspect 14, further comprising: transmitting a request to a remote server requesting to download the machine learning model, the machine learning model for inferring the target wireless communication device; and retrieving the machine learning model from the remote server in accordance with transmitting the request, the machine learning model corresponding to the environment of the first wireless communication device.
Aspect 21: The method of aspect 20, further comprising: retrieving the machine learning model from a local storage at the first wireless communication device, the machine learning model corresponding to the environment of the first wireless communication device.
Aspect 22: The method of any of aspects 14 through 21, further comprising: refraining from switching from a second wireless communication device connected to the first wireless communication device to a different wireless communication device in accordance with the second wireless communication device being the target wireless communication device indicated by the machine learning model.
Aspect 23: The method of aspect 14, further comprising: receiving a neighbor wireless communication device report comprising a list of neighbor wireless communication devices located within a threshold distance from the first wireless communication device and one or more capabilities associated with the wireless communication devices; and including the list of neighbor wireless communication devices in the plurality of parameters.
Aspect 24: The method of any of aspects 14 through 23, further comprising: refraining from scanning one or more additional wireless communication devices that are different form the target wireless communication device in accordance with the output of the machine learning model.
Aspect 25: The method of any of aspects 14 through 24, wherein associating with the target wireless communication device is in accordance with a traffic balancing requirement of a second wireless communication device.
Aspect 26: The method of any of aspects 14 through 25, further comprising: refraining from performing an wireless communication device scanning procedure during an inference stage of the machine learning model in accordance with the output of the machine learning model.
Aspect 27: The method of any of aspects 14 through 26, further comprising: associating with a second target wireless communication device during an inference stage of the machine learning model in accordance with a traffic profile of the first wireless communication device, a quality of service requirement at the first wireless communication device, or both.
Aspect 28: A first wireless communication device for wireless communication, comprising one or more memories storing processor-executable code, and one or more processors coupled with the one or more memories and individually or collectively operable to execute the code to cause the first wireless communication device to perform a method of any of aspects 1 through 13.
Aspect 29: A first wireless communication device for wireless communication, comprising at least one means for performing a method of any of aspects 1 through 13.
Aspect 30: A non-transitory computer-readable medium storing code for wireless communication, the code comprising instructions executable by one or more processors to perform a method of any of aspects 1 through 13.
Aspect 31: A first wireless communication device for wireless communications, comprising one or more memories storing processor-executable code, and one or more processors coupled with the one or more memories and individually or collectively operable to execute the code to cause the first wireless communication device to perform a method of any of aspects 14 through 27
Aspect 32: A first wireless communication device for wireless communications, comprising at least one means for performing a method of any of aspects 14 through 27
Aspect 33: A non-transitory computer-readable medium storing code for wireless communications, the code comprising instructions executable by one or more processors to perform a method of any of aspects 14 through 27

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions also may be physically located at various positions, including being distributed such that portions of functions are implemented at different physical locations. Also, as used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrases “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communications at a first wireless communication device comprising:
a processing system that includes processor circuitry and memory circuitry that stores code, the processing system configured to cause the apparatus to:
input a plurality of parameters into a machine learning model, the plurality of parameters comprising at least one of a location of the first wireless communication device, a second wireless communication device connected to the first wireless communication device, a received signal strength indicator value of the second wireless communication device, and a current time value;
receive a plurality of outputs of the machine learning model, the plurality of outputs comprising a list of wireless communication devices associated with the location of the first wireless communication device and a plurality of received signal strength indicator values associated with the list of wireless communication devices; and
associate with a target wireless communication device of the list of wireless communication devices in accordance with the plurality of outputs comprising the list of wireless communication devices and the plurality of received signal strength indicator values in accordance with the current time value.

2. The apparatus of claim 1, wherein the processing system is further configured to cause the first wireless communication device to:
input the plurality of parameters into the machine learning model, the plurality of parameters comprising at least one of a series of locations of the first wireless communication device corresponding to an initial portion of a trajectory or a series of received signal strength indicator values and a first set of wireless communication devices located along the initial portion of the trajectory; and
identify a predicted remainder of the trajectory of the first wireless communication device in accordance with inputting the series of parameters, the list of wireless communication devices corresponding to the remainder of the trajectory of the first wireless communication device.

3. The apparatus of claim 2, wherein associating with the target wireless communication device of the list of wireless communication devices is in accordance with identifying the remainder of the trajectory and the target wireless communication device comprising a next wireless communication device of the list of wireless communication devices along the trajectory.

4. The apparatus of claim 2, wherein, to identify the remainder of the trajectory, the processing system is further configured to cause the first wireless communication device to:
select a first trajectory of a plurality of candidate trajectories corresponding to the initial portion of the trajectory in accordance with the current time value.

5. The apparatus of claim 1, wherein, to associate with the target wireless communication device, the processing system is further configured to cause the first wireless communication device to:
select the target wireless communication device from the list of wireless communication devices in accordance with the plurality of received signal strength indicator values associated with the list of wireless communication devices, the list of wireless communication devices comprising a list of candidate wireless communication devices satisfying a threshold signal strength.

6. The apparatus of claim 1, wherein the plurality of outputs comprises a mapping of one or more candidate wireless communication devices of the list of wireless communication devices and received signal strength indicator values of the one or more candidate wireless communication devices, the received signal strength indicator values associated with an operating area corresponding to the first wireless communication device.

7. The apparatus of claim 1, wherein the processing system is further configured to cause the first wireless communication device to:
scan an environment of the first wireless communication device for one or more wireless communication devices of the list of wireless communication devices during a training stage associated with the machine learning model;
generate a plurality of training parameters for the machine learning model comprising a location of the one or more wireless communication devices, a received signal strength indicator value of each of the one or more wireless communication devices, or a combination thereof; and
locally update the machine learning model at the first wireless communication device according to the plurality of training parameters, sending the plurality of training parameters for model training to a remote server, or both, inputting the plurality of parameters into the machine learning model being in accordance with locally updating the machine learning model or sending the plurality of training parameters to the remote server.

8. The apparatus of claim 7, wherein one or more outputs of a remote machine learning model at the remote server are associated with a plurality of inputs from a plurality of first wireless communication devices.

9. The apparatus of claim 1, wherein the processing system is further configured to cause the first wireless communication device to:
transmit a request to a remote server requesting to download the machine learning model; and
retrieve the machine learning model from the remote server in accordance with transmitting the request, the machine learning model corresponding to a current operating area of the first wireless communication device.

10. The apparatus of claim 7, wherein the processing system is further configured to cause the first wireless communication device to:
retrieve the machine learning model from a local storage at the first wireless communication device, the machine learning model corresponding to the environment of the first wireless communication device.

11. The apparatus of claim 1, wherein the processing system is further configured to cause the first wireless communication device to:
refrain from performing an wireless communication device scanning procedure during an inference stage of the machine learning model in accordance with the plurality of outputs of the machine learning model.

12. The apparatus of claim 1, wherein the first wireless communication device is a station (STA), and wherein the second wireless communication device is an access point (AP).

13. The apparatus of claim 1, wherein the first wireless communication device is an access point (AP), and wherein the second wireless communication device is a station (STA).

14. An apparatus for wireless communications at a first wireless communication device, comprising:
a processing system that includes processor circuitry and memory circuitry that stores code, the processing system configured to cause the first wireless communication device to:
generate a plurality of parameters associated with an environment of the first wireless communication device for inputting into a machine learning model, the plurality of parameters comprising at least a location of the first wireless communication device, one or more received signal strength indicator values associated with one or more wireless communication devices, a traffic pattern of the first wireless communication device, and a current time value;
receive an output of the machine learning model in accordance with the plurality of parameters, the output comprising an indication of a target wireless communication device for communications in accordance with the plurality of parameters; and
associate with the target wireless communication device in accordance with the output.

15. The apparatus of claim 14, wherein the processing system is further configured to cause the first wireless communication device to:
perform a single scanning procedure for the target wireless communication device, associating with the target wireless communication device being in accordance with one or more performance thresholds at the target wireless communication device satisfying one or more thresholds according to the single scanning procedure.

16. The apparatus of claim 14, wherein the processing system is further configured to cause the first wireless communication device to:
select a reward function for the machine learning model in accordance with a service level agreement requirement of the first wireless communication device, receiving the indication of the target wireless communication device being in accordance with the reward function.

17. The apparatus of claim 16, wherein the reward function is in accordance with a throughput, a quality of service, a latency, a roaming overhead, an absence of a service level agreement requirement of the first wireless communication device, or any combination thereof.

18. The apparatus of claim 14, wherein the processing system is further configured to cause the first wireless communication device to:
scan an environment of the first wireless communication device for one or more wireless communication devices during a training stage for the machine learning model;
generate a plurality of training parameters for the machine learning model comprising a location of the one or more wireless communication devices, a received signal strength indicator value of the one or more wireless communication devices, or a combination thereof; and
locally update the machine learning model at the first wireless communication device according to the plurality of training parameters, sending the plurality of training parameters for model training to a remote server, or both, inputting the plurality of parameters into the machine learning model being in accordance with locally updating the machine learning model or sending the plurality of training parameters to the remote server.

19. The apparatus of claim 18, wherein one or more outputs of a remote machine learning model at the remote server are associated with a plurality of inputs from a plurality of first wireless communication devices.

20. The apparatus of claim 14, wherein the processing system is further configured to cause the first wireless communication device to:
transmit a request to a remote server requesting to download the machine learning model, the machine learning model for inferring the target wireless communication device; and
retrieve the machine learning model from the remote server in accordance with transmitting the request, the machine learning model corresponding to the environment of the first wireless communication device.

21. The apparatus of claim 14, wherein the processing system is further configured to cause the first wireless communication device to:
retrieve the machine learning model from a local storage at the first wireless communication device, the machine learning model corresponding to the environment of the first wireless communication device.

22. The apparatus of claim 14, wherein the processing system is further configured to cause the first wireless communication device to:
refrain from switching from a second wireless communication device connected to the first wireless communication device to a different wireless communication device in accordance with the second wireless communication device being the target wireless communication device indicated by the machine learning model.

23. The apparatus of claim 14, wherein the processing system is further configured to cause the first wireless communication device to:
receive a neighbor wireless communication device report comprising a list of neighbor wireless communication devices located within a threshold distance from the first wireless communication device and one or more capabilities associated with the neighbor wireless communication devices; and
include the list of neighbor wireless communication devices in the plurality of parameters.

24. The apparatus of claim 14, wherein the processing system is further configured to cause the first wireless communication device to:
refrain from scanning one or more additional wireless communication devices that are different form the target wireless communication device in accordance with the output of the machine learning model.

25. The apparatus of claim 14, wherein associating with the target wireless communication device is in accordance with a traffic balancing requirement of a second wireless communication device.

26. The apparatus of claim 14, wherein the processing system is further configured to cause the first wireless communication device to:
refrain from performing an wireless communication device scanning procedure during an inference stage of the machine learning model in accordance with the output of the machine learning model.

27. The apparatus of claim 14, wherein the processing system is further configured to cause the first wireless communication device to:
associate with a second target wireless communication device during an inference stage of the machine learning model in accordance with a traffic profile of the first wireless communication device, a quality of service requirement at the first wireless communication device, or both.

28. A method for wireless communication at a first wireless communication device, comprising:
inputting a plurality of parameters into a machine learning model, the plurality of parameters comprising at least one of a location of the first wireless communication device, a second wireless communication device connected to the first wireless communication device, a received signal strength indicator value of the second wireless communication device, and a current time value;
receiving a plurality of outputs of the machine learning model, the plurality of outputs comprising a list of wireless communication devices associated with the location of the first wireless communication device and a plurality of received signal strength indicator values associated with the list of wireless communication devices; and
associating with a target wireless communication device of the list of wireless communication devices in accordance with the plurality of outputs comprising the list of wireless communication devices and the plurality of received signal strength indicator values in accordance with the current time value.

29. The method of claim 28, further comprising:
inputting the plurality of parameters into the machine learning model, the plurality of parameters comprising at least one of a series of locations of the first wireless communication device corresponding to an initial portion of a trajectory or a series of received signal strength indicator values and a first set of wireless communication devices located along the initial portion of the trajectory; and
identifying a predicted remainder of the trajectory of the first wireless communication device in accordance with inputting the series of parameters, the list of wireless communication devices corresponding to the remainder of the trajectory of the first wireless communication device.

30. A method for wireless communications at a first wireless communication device, comprising:
generating a plurality of parameters associated with an environment of the first wireless communication device for inputting into a machine learning model, the plurality of parameters comprising at least a location of the first wireless communication device, one or more received signal strength indicator values associated with one or more wireless communication devices, a traffic pattern of the first wireless communication device, and a current time value;
receiving an output of the machine learning model in accordance with the plurality of parameters, the output comprising an indication of a target wireless communication device for communications in accordance with the plurality of parameters; and
associating with the target wireless communication device in accordance with the output.
